(19) United States
(12) Patent Application Publication
(10) Pub. No.: US 2018/0058088 A1
(43) Pub. Date: Mar. 1, 2018

(54) SYSTEMS AND METHODS TO PREVENT THE INGRESS OF WATER USING A TEMPORARY, REMOVABLE IMPERVIOUS SHEET

(71) Applicant: William Clohessy, Cratloe (IE)

(72) Inventor: William Clohessy, Cratloe (IE)

(21) Appl. No.: 15/563,340

(22) PCT Filed: Aug. 12, 2015
(86) PCT No.: PCT/EP2015/068603

§ 371 Date: Sep. 29, 2017

(30) Foreign Application Priority Data
Apr. 1, 2015 (AU) 2015901179

(51) Int. Cl. E04H 9/14; E04B 1/66; B32B 5/02; B32B 7/14; B32B 27/12; B32B 27/32

(52) U.S. Cl. CPC E04H 9/145; E04B 1/665; B32B 5/022; B32B 7/14; B32B 2405/00; B32B 27/32; B32B 2262/0253; B32B 2307/402; B32B 2307/7265; B32B 27/12

(57) ABSTRACT

Removable water barriers for inhibiting the ingress of water into a structure are provided. A barrier can be formed from a flexible sheet. The flexible sheet may include a first layer formed from non-woven polypropylene and a second layer formed from high density polyethylene. Adhesive strips may be pre-applied to a rear surface of the flexible sheet for adhering the sheet to a structure or adjacent sheets. A fold line may be provided, such that a lower portion of the sheet can be folded to extend outwards from an upper portion along the ground. Sandbags can be stacked on the lower portion for hold the flexible sheet in place and further inhibit the ingress of water. Also provided are methods for preventing the ingress of water using a flexible sheet.

### FIELD OF THE INVENTION

The present invention relates to barriers and the use thereof to prevent the ingress of water and the like into and within buildings and dwellings. The invention has particular application but not exclusive application in flood situations. The invention is not limited to these applications and can be used in other situations such as preventing the ingress of saltwater from an encroaching sea.

### BACKGROUND OF THE INVENTION

To prevent the ingress of water into buildings, sandbags have been laid on top of each other to form a barrier. However, water still seeps through.

Heavy gauge plastic sheeting has been used to provide an impervious barrier. The sheeting is usually held in place by duct tape. The sheeting commonly fails for various reasons. In some cases, the duct tape has limited adhesion to the plastic sheeting and when exposed to water loses its adhesive properties, such that the plastic sheeting falls down.

Further, the plastic sheeting can suffer from being easily torn in areas where the sheeting goes around sharp corners. These tears affect the integrity of the sheeting and allow water to pass through the tears.

Such water barriers are sometimes deployed during rapidly-developing storms or other emergency situations. In some circumstances, water barriers must be erected over large areas very quickly. In some circumstances, water barriers are erected by volunteers, homeowners, business owners or other individuals having little experience or expertise in water barrier deployment. Enabling rapid and simple deployment of a highly-effective water barrier may be beneficial in minimizing property damage and other losses.

### SUMMARY

In accordance with some embodiments, a water impervious barrier is provided which is adapted for rapid deployment to effectively prevent water ingress, without significant levels of user expertise.

In some embodiments, an impervious sheet is provided including a first layer of non-woven polypropylene (PP) and a second layer of impervious high density polyethylene (HDPE). The two layers are preferably heat fused together to form a single sheet. The non-woven polypropylene is preferably strong and tear resistant while being flexible. The non-woven polypropylene is preferably coloured to alert a person that the sheet is a water barrier. Preferably the colour of the non-woven polypropylene is a high visibility colour.

The sheet is preferably made in rolls of 1 meter widths. The sheet is preferably made in continuous rolls. The sheet is preferably made in rolls of 20 meter lengths.

In some embodiments, the impervious sheet has at least one adhesive strip extending along the longitudinal axis of the sheet, preferably at or near an upper edge of the sheet and on the sheet's rear surface.

In some embodiments, the impervious sheet has two adhesive strips both of which extend along the longitudinal axis, one at or near an upper edge of the sheet and one at or near a lower edge of the sheet. The adhesive of the adhesive strip is preferably water resistant.

The sheet can have one or more laterally extending adhesive strips across the width of the sheet, i.e. spanning approximately the upper edge of the sheet and approximately the lower edge of the sheet. Where there are two or more laterally extending adhesive strips, they are typically spaced apart from each other along the length of the sheet.

The adhesive strips preferably extend along the side with the HDPE layer.

The adhesive strips are preferably activated prior to use. The adhesive strips are preferably activated by removing a backing layer from the adhesive.

Preferably the sheet is installed by positioning the rear HDPE layer against a building or structure and the coloured PP layer facing outwards.

Where there is a single longitudinally-extending adhesive strip, it is preferably positioned uppermost. In some embodiments, where there is a single longitudinally-extending adhesive strip and it is positioned uppermost, the lower section of the sheet is held in position by one or more sandbags or the like. In a preferred form the lower section of the sheet extends outwardly from the structure being protected to allow sandbags and the like to be positioned thereon.

Where there are two longitudinally-extending adhesive strips, the sheet is preferably positioned substantially flush with the building or structure and the sheet is substantially sealed to the building or structure.

Two separate sheets can be made to form a substantially continuous impervious barrier by joining the overlapping two sheets by using the adhesive of a laterally extending adhesive strip on one of the sheets to bond with the other sheet or using joiner tape to either bond the side of each sheet to the building or structure or bond the side of each sheet to the adjacent sheet. The joiner tape is preferably double sided tape. The joiner tape preferably uses the same adhesive as the adhesive of the adhesive strips, such as a water resistant adhesive.

In another aspect, a system is provided to inhibit the ingress of water into a building or structure, said system including having one or more impervious sheets as described above; activating the adhesive of the one or more adhesive strips of the one or more impervious sheets; and positioning the impervious sheets against a building or structure.

In another aspect, a system includes a stability base and handle between which a roll of impervious sheet can be secured. In another aspect, methods are provided for inhibiting the ingress of water using an impervious sheet.

These and other devices, systems and method are described herein. The features described with respect to one aspect may, in other embodiments, also apply where applicable to all other aspects. Furthermore, different combinations of described features are herein described and may be claimed even when not expressly stated.

### BRIEF DESCRIPTION OF THE DRAWINGS

In order that the present embodiments can be more readily understood, reference will now be made to the accompanying drawings which illustrate certain preferred embodiments.

FIG. 1 is a cutaway rear elevation of an impervious sheet, in accordance with a first embodiment.

FIG. 2 is a diagrammatic front view of the impervious sheet of FIG. 1, applied to a building.

FIG. 3A is an exploded perspective view of impervious sheet roll with stability base and handle facilitating deployment.

FIG. 3B is a perspective view of the embodiment of FIG. 3A, assembled for use.

FIG. 3C is a perspective view of the embodiment of 3B, in mid deployment.

FIG. 4 is a diagrammatic front view of an impervious sheet, in accordance with another embodiment.

FIG. 5 is a diagrammatic rear view of the embodiment of FIG. 4.

FIG. 6 is a diagrammatic front view of the embodiment of FIG. 4, as applied to a structure.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention and is not intended to limit the invention to the embodiments illustrated.

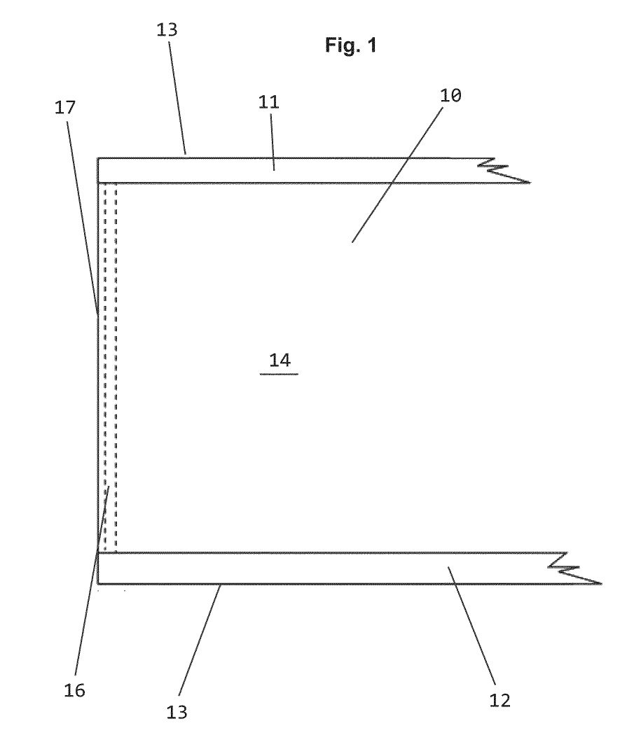

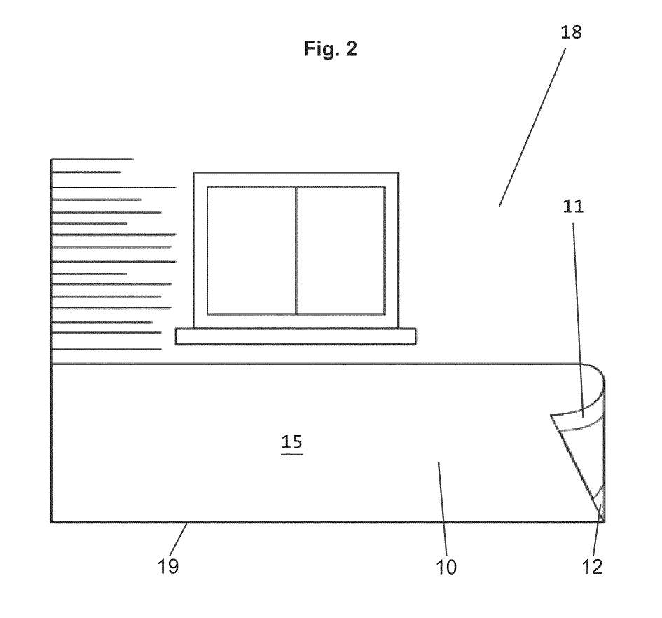

With reference to FIGS. 1 and 2, there is shown a first preferred embodiment of an impervious sheet. The impervious sheet 10 includes two heat-fused layers. The first layer is a non-woven polypropylene while the second layer is an impervious high-density polyethylene. The high-density polyethylene layer prevents water from passing through the sheet 10. The non-woven polypropylene layer provides sheet 10 with integrity and flexibility which provides substantial tear and puncture resistance. Sheet 10 has two longitudinally extending adhesive strips 11 and 12 that are positioned adjacent opposed longitudinal edges 13. The adhesive strips 11 and 12 are positioned on the inner side 14 of sheet 10 that has the impervious high-density polyethylene layer. The opposing outer side 15 is preferably brightly coloured, potentially alerting people to the presence of the sheeting 10. In some embodiments, some or all surfaces of sheet 10 (preferably including at least outer surface 15) are bright orange or red in color, facilitating visibility in emergency and/or low light conditions.

In a preferred form, the top adhesive strip 11 and the bottom adhesive strip 12 have a width of approximately 3cm and 5cm respectively. Both adhesive strips 11 and 12 have a wax paper cover that can be peeled off when the adhesive needs to be activated and used. The adhesive of bottom strip 12 is preferably water resistant. The adhesive of top strip 11 may also be water resistant.

In some embodiments, sheet 10 is provided on a roll and it is unrolled during its installation. In some embodiments, the sheet 10 has a width of about 1 metre and a length of 20 or 25 metres. For locations requiring a water barrier length less than the full length of sheet 10, sheet 10 may be cut by the user, typically in a lateral direction generally parallel with end 17. For locations requiring a water barrier length greater than that of sheet 10 (or remnants thereof remaining after cutting), multiple sheets may be joined together. Multiple sheets can be joined together by overlapping a short section of the sheets, with the back side of one sheet overlapping and contacting the front side of an adjacent sheet.

In some embodiments, lateral adhesive strips are provided on or applied to an impervious sheet to facilitate joining of the sheet with an adjacent sheet section, or to a building or other structure. For example, lateral adhesive strip 16 is provided on the back side 14 of sheet 10. Adhesive strip 16 may be incorporated into sheet 10, similarly to adhesive strips 11 and 12, or it may be applied by a user during installation, such as via application of a strip of double-sided joiner tape.

With particular reference to FIG. 2, there is shown a sheet 10 being installed on the side of a building 18. Sheet 10 is installed with the inner side 14 having the impervious HDPE layer flush against the building or structure wall. The outer side 15 having a non-woven polypropylene layer is installed facing outwardly. During installation, sheet 10 is positioned substantially flush with building 18 so that the lower sheet edge 19 abuts a ground surface adjacent the building or structural wall, such as a foundation slab, pavement or other surrounding surface. During installation, the wax paper backing of upper longitudinal adhesive strip 11 may be peeled away so that adhesive strip 11 adheres to the surface of building 18, thereby holding sheet 10 in place. Similarly, lower longitudinal adhesive strip 12 may be adhered to building 18 or a proximate ground surface to further secure sheet 10 and minimize water ingress.

In some circumstances, such as prior to or during the onset of a storm or other emergency situation, it may be necessary to install the water barrier rapidly and potentially over large installation areas. Limited personnel may be available to assist with the installation. Installation personnel, such as individual homeowners, small business owners or volunteers, may have little training in effective barrier deployment. For these and other reasons, it may be desirable to provide embodiments of water barriers disclosed herein in a form that facilitates rapid and easy deployment.

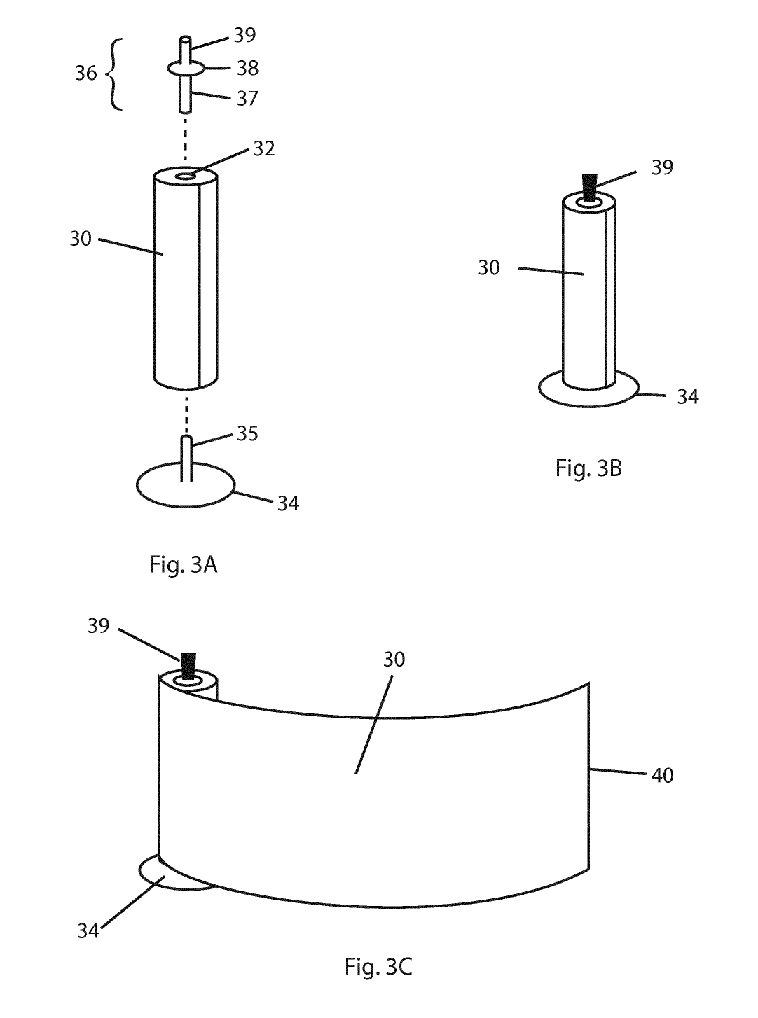

FIG. 3 illustrates one such embodiment, in which water impervious sheet 30 is constructed similarly to sheet 10, and provided in a roll form. FIG. 3A illustrates an exploded view of water impervious sheet roll 30, as installed using support base 34 and support handle 36. Hollow core 32 extends laterally through the center of roll 30, and is preferably a tube formed from a rigid, water-resistant material around which sheet 30 is wrapped. Deployment of roll 30 is facilitated by support base 34 and support handle 36. In use, support base 34 is positioned against a ground surface proximate the location of installation, and includes perpendicular lower support pin 35. The diameter of support pin 35 is adapted for insertion into the bottom end of hollow core 32. Support handle 36 includes upper support pin 37, flange 38 and handle portion 39. Upper support pin 37 is inserted into the upper end of hollow core 32. Flange 38 rests against the top end of roll 30, while handle 39 provides a convenient location for manual support by a user.

FIG. 3B illustrates the sheet deployment arrangement of FIG. 3A, as assembled for use. FIG. 3C illustrates the sheet deployment arrangement of FIG. 3A in actual use. In some use cases, one individual may hold handle 39 to control the position and orientation of roll 30, while a second individual pulls leading end 40 of sheet 30 across the location at which the barrier is to be installed. In this way, sheet 30 can thereby be rapidly unrolled and installed by two individuals.

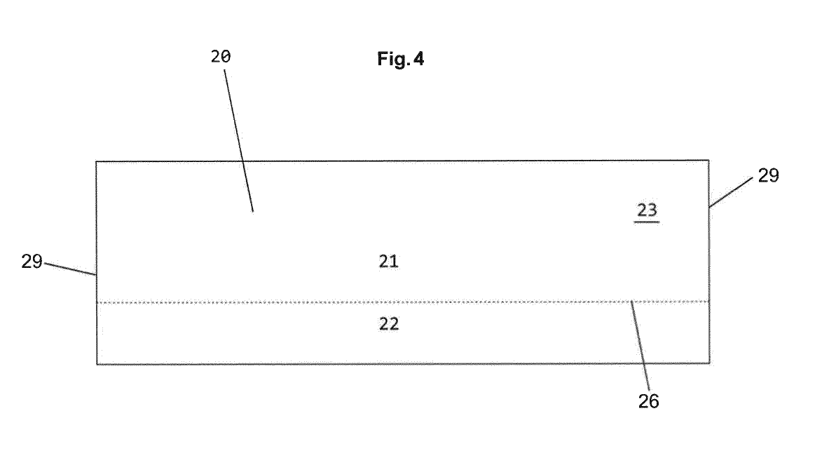

Another embodiment is shown in FIGS. 4, 5 and 6. FIG. 4 is a front elevation of water barrier sheet 20. Sheet 20 comprises a first layer of non-woven polypropylene and a second impervious layer of high-density polyethylene. The non-woven polypropylene layer is brightly coloured to alert people of the product and provide enhanced visibility. Like the embodiment of FIG. 1, sheet 20 has a width of approximately 1 metre. In the embodiment of FIG. 4, the width of sheet 20 is divided into two unequal sections: upper section 21, having a width of approximately 70 cm, and lower section 22 having a width of approximately 30 cm. Sections 21 and 22 are demarcated by fold line 26. In some embodiments, fold line 26 will be formed as a visual cue, such as a dotted line, dashed line or other indicia printed on front and/or back surfaces of sheet 20. In other embodiments, fold line 26 will optionally include an associated physical structure to facilitate folding along the length of line 26, such as a pre-fold, weld or line of weakness.

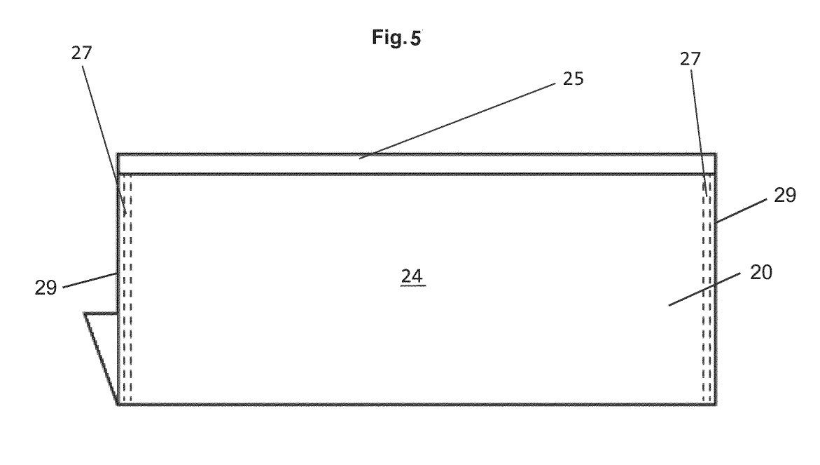

FIG. 5 provides a rear perspective view of sheet 20, as folded long line 26 when prepare for installation. A longitudinally extended adhesive strip 25 of approximately 3 cm in width runs proximate a top edge of sheet 20. In the illustrated embodiment, there is no bottom longitudinally extended adhesive strip. Sheet 20 is preferably installed with the non-woven polypropylene layer on the outer side 23 while the high-density polyethylene layer is on the inner side 24. Adhesive strip 25 extends along the top edge of inner side 24.

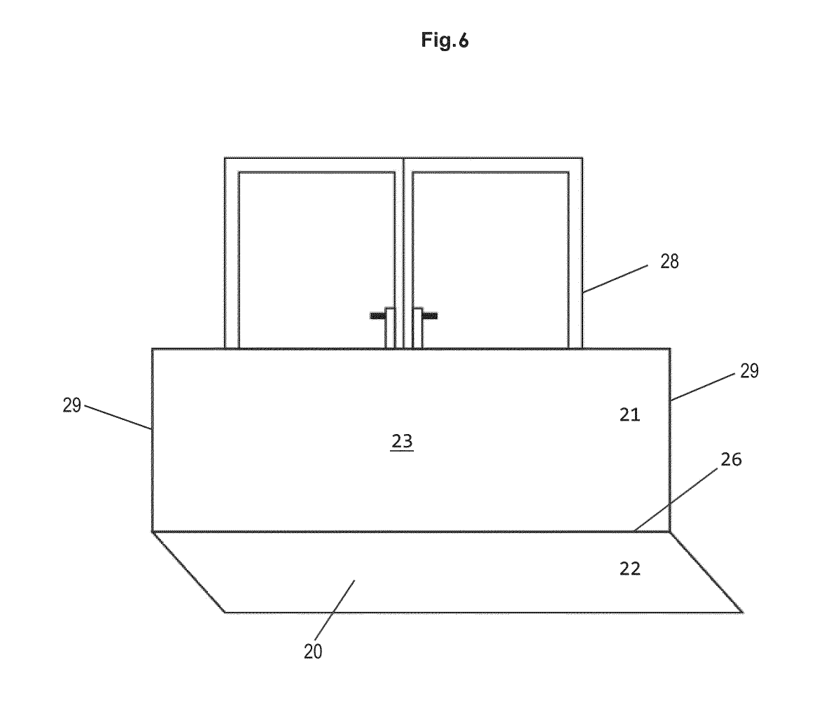

FIG. 6 illustrates sheet 20, as installed against an exemplary structured comprised of a building doorway 28. Preferably, sheet 20 is provided with a wax paper adhesive cover strip over adhesive strip 25. Sheet 20 is installed by peeling of the wax paper cover and allowing adhesive strip 25 to bond to the side of a building or structure along which sheet 20 is installed (e.g. doorway 28 and/or surrounding walls). Lower section 22 is folded outward along fold line 26, generally perpendicular to, and extending outwards from, upper section 21. Upper section 21 is installed abutting the side of the building or structure for which the barrier is intended to prevent water ingress, while lower section 22 is installed abutting a slab, pavement or other surface adjacent the building. Sandbags or the like can then be positioned on top of lower section 22 proximate the fold line 26 to help keep sheet 20 in place and help prevent water ingress beneath sheet 20. The ends 29 of sheet 20 can be held in place with the use of end adhesive strips 27 extending between an upper edge of sheet 20 and a lower edge of sheet 20 in a lateral direction. In some embodiments, end adhesive strips 27 may be formed from double sided joiner tape. In other embodiments, end adhesive strips 27 may be integrated within sheet 20 similarly to adhesive strip 25, e.g., applied to sheet 20 prior to installation.

In some embodiments, sheet 20 is provided having a length specifically suited to span a typically-sized doorway or window, thereby facilitating rapid installation in common usage scenarios.

Sheets 10, 20 and 30 are each adapted for positioning around and over sharp or squared off edges while resisting or eliminating unintentional punctures and tears. When installed in a location proximate fittings or pipes, sheets 10, 20 and 30 can be cut to fit around the fittings and pipes. In these use cases, the sheets will preferably be sealed around the cutouts, such as via the application of double-sided joiner tape on the sheet back side, around the cutout location. Such a sealing technique can inhibit infiltration of water behind the sheets at the cutout locations.

Some embodiments described herein may provide certain advantages in practical applications. For example, exemplary sheet constructions comprising of two different layers with complementary properties may help enable the sheet to be tear and puncture resistant and impervious to the passage of water there-through. Using such an impervious sheet provides an effective barrier to prevent the ingress of water and the like inside a building or structure or through different parts of the building or structure. Embodiments of the sheet may be very easy to use and install. Some embodiments may be implemented as a relatively cheap and/or disposable product. Some embodiments can be installed very quickly in the case of a sudden flood from a burst water main or from the rising levels of a swollen river. Some embodiments can also be used to prevent the passage of seawater into a home during storms and cyclones or in the circumstances of high sea levels resulting from an abnormally high tide.

It will of course be realised that while the foregoing has been given by way of illustrative examples of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

What is claimed:

1. A temporary, removable water barrier comprising:
a first flexible barrier sheet comprising a first layer formed from non-woven polypropylene and a second layer formed from high density polyethylene.

2. The barrier of claim 1, in which the first layer and the second layer are heat-fused together.

3. The barrier of claim 1, in which said first layer is a high visibility color.

4. The barrier of claim 1, in which the first layer forms a front surface, and the second layer forms a rear surface; further comprising a first adhesive strip proximate an upper edge of the rear surface.

5. The barrier of claim 4, in which the first adhesive strip comprises water resistant adhesive.

6. The barrier of claim 5, in which the first adhesive strip is activated by removal of a wax paper cover strip.

7. The barrier of claim 4, further comprising a second adhesive strip proximate a lower edge of the rear surface.

8. The barrier of claim 7, in which the second adhesive strip comprises water resistant adhesive.

9. The barrier of claim 1, further comprising one or more end adhesive strips extending laterally between upper and lower edges of the first flexible barrier sheet, on a rear surface of the first flexible barrier sheet.

10. The barrier of claim 9, in which the end adhesive strips are applied to the barrier prior to installation.

11. The barrier of claim 10, in which the end adhesive strips comprise double-sided joiner tape applied during barrier installation.

12. The barrier of claim 9, further comprising a second flexible barrier sheet, where an end of the first flexible barrier sheet is installed overlapping an end of the second flexible barrier sheet, at least one of the end adhesive strips adhering the first flexible barrier sheet to the second flexible barrier sheet.

13. The barrier of claim 1, in which the first flexible barrier sheet comprises an upper section and a lower section, the upper section divided from the lower section by a fold line extending longitudinally along the length of the first flexible barrier sheet.

14. The barrier of claim 13, in which the upper section comprises approximately 70% of the first flexible barrier sheet width, and the lower section comprises approximately 30% of the first flexible barrier sheet width.

15. The barrier of claim 13, in which the upper section is installed proximate a structure from which the barrier inhibits water ingress, and the lower section is installed proximate a ground surface outside the structure.

16. The barrier of claim 13, further comprising sandbags placed atop the lower section, proximate the fold line.

17. The barrier of claim 1, in which the first flexible barrier sheet is wrapped into a roll around a hollow core.

18. The barrier of claim 17, in which the first flexible barrier sheet is approximately 1 meter wide and 25 meters long.

19. The barrier of claim 17, further comprising:
a support base comprising a flat bottom surface and a lower support pin perpendicular to the bottom surface, the lower support pin having a diameter facilitating insertion of the lower support pin into an end of the roll hollow core; and
a support handle comprising an upper support pin, the upper support pin having a diameter facilitating insertion of the upper support pin into an end of the roll hollow core;
whereby the roll can rotate around the support base and support handle during deployment of the first flexible barrier sheet.

20. The barrier of claim 19, in which the support handle further comprises a flange extending perpendicularly relative to the upper support pin, and a handle portion attached above the flange.

21. A removable water barrier comprising:
a first flexible barrier sheet having a front surface, a rear surface, a top edge and a bottom edge; and
a first pre-applied adhesive strip on the barrier sheet rear surface extending longitudinally proximate the top edge.

22. The removable water barrier of claim 21, further comprising a second pre-applied adhesive strip on the barrier sheet rear surface extending longitudinally proximate the bottom edge.

23. The removable water barrier of claim 22, in which the first flexible barrier sheet has a width of approximately 1 meter, the first pre-applied adhesive strip has a width of approximately 3 cm, and the second pre-applied adhesive strip has a width of approximately 5 cm.

24. The removable water barrier of claim 21, in which the first flexible barrier sheet comprises an upper section and a lower section, the upper section divided from the lower section by a fold line extending longitudinally along the length of the first flexible barrier sheet.

25. The removable water barrier of claim 24, in which the upper section is installed proximate a structure from which the barrier inhibits water ingress, and the lower section is installed proximate a ground surface outside the structure.

26. The removable water barrier of claim 25, further comprising sandbags placed atop the lower section, proximate the fold line.

27. The removable water barrier of claim 21, in which the first flexible barrier sheet is wrapped into a roll around a hollow core.

28. The removable water barrier of claim 27, further comprising:
a support base comprising a flat bottom surface and a lower support pin perpendicular to the bottom surface, the lower support pin having a diameter facilitating insertion of the lower support pin into an end of the roll hollow core; and
a support handle comprising an upper support pin, the upper support pin having a diameter facilitating insertion of the upper support pin into an end of the roll hollow core;
whereby the roll can rotate around the support base and support handle during deployment of the first flexible barrier sheet.

29. The removable water barrier of claim 28, in which the support handle further comprises a flange extending perpendicularly relative to the upper support pin, and a handle portion attached above the flange.

30. A method for inhibiting ingress of water into a structure using a temporary water barrier, the method comprising the steps of:
positioning a first flexible barrier sheet along an exterior perimeter of a structure, the barrier sheet having a lower edge proximate a ground surface outside the structure; and
securing the first flexible barrier sheet to the structure using a first pre-applied adhesive strip along an upper edge of a rear surface of the first flexible barrier sheet.

31. The method of claim 30, in which the step of positioning a first flexible barrier sheet comprises the substeps of:
folding the first flexible barrier sheet along a fold line demarcating an upper portion of the first flexible barrier sheet and a lower portion of the first flexible barrier sheet; and
positioning the first flexible barrier sheet such that its upper portion is proximate the structure and the lower portion is proximate the ground surface.

32. The method of claim 31, further comprising the step of positioning sandbags atop the lower portion of the first flexible barrier sheet.

33. The method of claim 30, further comprising: securing the first flexible barrier sheet to the structure using a second pre-applied adhesive strip along a lower edge of a rear surface of the first flexible barrier sheet.

34. The method of claim 30, in which the step of positioning a first flexible barrier sheet further comprises the substeps of:
positioning a stability base proximate the exterior perimeter of the structure, the stability base comprising a bottom portion resting on the ground surface and a lower support pin extending vertically from the bottom portion;
installing a barrier roll onto the stability base, the barrier roll comprising the first flexible barrier sheet wrapped around a hollow core, the hollow core having a lower end into which the lower support pin is inserted;
installing a stability handle on the barrier roll by inserting a portion of the stability handle into an upper end of the hollow core; and
pulling an end of the barrier roll along the exterior perimeter of the structure, such that the barrier roll unrolls by rotating around the lower support pin and stability handle.
